(19) United States
(12) Patent Application Publication
(10) Pub. No.: US 2002/0078185 A1
(43) Pub. Date: Jun. 20, 2002

(54) Method and arrangement for configuring a mobile telephone

(76) Inventors: Jan Swerup, Knivsta (SE); Stefan Macklin, Sodertalje (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/013,471

(22) Filed: Dec. 13, 2001

(30) Foreign Application Priority Data
Dec. 15, 2000 (SE) 0004693-8

(51) Int. Cl. G06F 15/16; G06F 15/177

(52) U.S. Cl. 709/220; 709/249; 709/246

(57) ABSTRACT

The invention relates to a method and a start site (5) for configuring a mobile telephone (1) for access to digital communication services. The invention also relates to a mobile telephone which on delivery from the shelf is pre-configured with a telephone number that goes to the start site. The start site comprises a server (8) and a data base (9). When the start site receives a call from a subscriber it requests the subscriber, by presenting text pages in the mobile's display, to select network operator and e-mail provider. Configuration data relating to access of the selected operator's digital services, and to the selected e-mail provider's services, including personalized information, are fetched from the data base and are placed in a configuration message which is transmitted to the mobile telephone. Upon receipt of the configuration message the mobile performs an automatic configuration process. Wap enabled telephones and SMS or OTA configuration messages may be used.

### TECHNICAL FIELD OF THE INVENTION

The invention generally refers to configuration of mobile telephones, which provide Internet access over radio. In particular the invention relates to a novel method and arrangement for configuration of mobile telephones for digital services, such as Internet based services and “wireless” e-mail.

A mobile telephone that provides Internet access over radio is provided with client software that allows reading and display of text, typically so called home pages or web pages, or information structured in a manner known by the client software.

The digital services referred to above are sometimes called data communication services. Typically such services comprise Internet access, “wireless” e-mail, and access to computer based applications.

### DESCRIPTION OF RELATED ART

WAP is an open global standard for communication between a mobile hand set and the Internet or other computer applications, defined by the WAP forum (http://www.wapforum.org). Key WAP application categories include “wireless” e-mail, wireless access to personal information, wireless access to Internet content, wireless access to corporate IT-systems and intelligent telephony services.

The GSM standard includes the SMS service which allows a customer to send and receive short text messages on his mobile telephone. The GSM standard even foresees so called configuration SMS messages. A configuration message contains information for configuring a mobile telephone for new services. When the mobile telephone receives a configuration SMS message the display on the mobile telephone will present the question “Do you accept your telephone is configured by the information contained in this message? YES/NO?”. If the customer answers “YES” software within the ordinary mobile telephone will automatically configure the telephone.

WO 9914965 relates to a method for configuring a mobile telephone by remote access. The required settings of the telephone are sent over a radio interface, e.g. in a SMS message, from a service provider and have it include the correct information.

WO 9914965 relates to a method for configuring a mobile telephone by remote access. The required settings of the telephone are sent over a radio interface, e.g. in a SMS message, from a service provider and have it include the correct information.

There is a web site owned by Ericsson, http://www.mobileinternet.ericsson.com/default_web.asp, that allows for configuration of a mobile telephone. The web site is accessed from a PC. At the web site mobile telephony operator and e-mail provider is selected. The user must also state the mobile telephone number of the mobile telephone to be configured. When the selections have been made the user presses enter and the corresponding information is entered into an SMS message together with other necessary configuration information which is fetched from a database. A configuring SMS message is sent over radio in the GSM mobile telephone network to the mobile telephone number. When receiving the SMS message the user will follow the above described procedures in order to configure his mobile telephone.

When a customer buys a mobile telephone he also receives a SIM card which identifies the mobile network operator as well as the services associated with the subscription. The customer inserts the SIM card into the mobile telephone, enters his PIN code and can instantly make a telephone call.

If the customer subscribes to digital services his SIM card will reflect this. Typically a customer will, when subscribing to the mobile telephony service, also subscribe to the digital short message service, SMS. Before the customer can access other digital services he must configure his mobile telephone for those digital services. To this end a set of menus appearing in a display of the mobile telephone will guide the customer through the configuration process. The menus will request the customer to provide information that the customer does not understand. Many of the different settings to be done during the configuration process are conceivable only to persons that have a great knowledge in mobile telephony and computer technology. To ordinary people, however, navigation through the various menus is perceived incomprehensive. Also the text used in the various menus is perceived difficult, as it relates to unknown entities. Ordinary people may therefor have objections to the use of mobile telephones, since ordinary people have a natural view of a telephone as an easy to use device.

### SUMMARY OF THE INVENTION

From the above it is evident that the required settings of a mobile telephone can be configured by a configuration message. One problem is accordingly to have someone to send the configuration message. Another problem is to enter the required information on the mobile telephone under guidance from instructions that are easy to understand.

In accordance with the present invention the mobile telephone is preconfigured with a telephone number that leads to a so-called start site. Preferably the pre-configuration is made in connection with the manufacture of the mobile telephone. When a customer buys the mobile telephone the first thing he/she does in order to configure it for digital services is to make an ordinary call to the pre-configured telephone number. The start site interacts, via client software, with the mobile telephone and the customer to obtain required information. The customer is requested to select network operator, that is provider of the digital services, from a list of network operators. Typically the customer is also asked if he/she wants to configure “wireless e-mail”. The customer answers the questions and the corresponding information is transmitted to the star site. The start site assembles this information with information already existing in its database and composes a configuration message which it transmits to the mobile telephone. On receipt of the configuration message the mobile telephone will present the question “Do you accept your telephone is configured by the information contained in this message? YES/NO?”. If the customer answers “YES” software within the mobile telephone will automatically configure the telephone.

When the configuration is completed the digital services can be accessed from the mobile telephone. In this manner the mobile telephone is configured almost automatically.

An example of a mobile telephone that needs to be configured for digital services is a WAP enabled mobile telephone. WAP is an acronym for Wireless Application Protocol. In the future other protocols for accessing Internet over radio may develop and those telephones may be called by other acronyms. A WAP enabled mobile telephone, for example a so-called smart phone, comprises a WAP browser for reading of WAP pages.

The interaction between the start site and the mobile telephone typically takes place by downloading, from the start site, text which is presented to the customer in the display of the mobile telephone. The text is formatted in accordance with any of the formats used by the client software provided in the mobile telephone. In the alternative the text pages are not downloaded, but are already stored in a memory of the mobile telephone.

Typically the configuration message is sent to the mobile telephone either in a so called OTA configuration message (over the air message), in a SMS configuration message or in an application specific configuration message. An OTA or SMS configuration message is transmitted from the start site to the mobile telephone either via different networks or directly over a public land mobile network (PLMN). It may thus be sent either via Internet to an OTA or SMS message centre and from there via a PLMN to the mobile telephone or directly to the OTA or SMS centre and from there via PLMN to the mobile telephone, thus avoiding internet transmission, or from the start site directly to the mobile telephone over a PLMN.

The next time the customer makes a data call he will not log on to the start site's Internet gate-way but to an Internet gate-way, for example a WAP gate-way, which belongs to the selected network operator.

To the customer the invention has the advantage that simple understandable questions need to be answered in order to configure the mobile telephone. To the network operator the invention has the advantage that soon after a customer has signed the subscription the customer will start using the digital services, thereby contributing to an increased profit. Network operators will thus have an incitement to quickly provide the start site with information on their modem pools and Internet gate-ways. To the e-mail provider and his customers the invention has the advantage that the customers will be able to configure the e-mail service from the mobile telephone. Prior to this invention a separate PC was required for this purpose. Not all customers have a PC. With the invention it is sufficient to have a mobile telephone only.

The start site is a node that comprises server software that interacts with client software resident in the mobile telephones. The start site is coupled to PSTN (or ISDN) and Internet, to PSTN (or ISDN) and an OTA centre (or an SMS centre), or to PSTN only or to Internet only.

The configuration process is simplified if the selected network operator and the selected e-mail provider both have provided the start site with the respective user-ID and password of the calling customer. If this information is in the start site's data base when the customer makes his/her call the customer need only select network operator and e-mail provider in order to complete the configuration.

If the customer's user-ID and password are not stored in the start site's database at the time he/she makes the call to the start site further text will be displayed in the to the customer, requesting him to provide this information. When the requested information is received at the start site, it will be put in the configuration message.

If the customer does not have an existing e-mail account the start site will offer the customer an “wireless” e-mail account with the start site, with the network operator the customer selected, or with another e-mail supplier.

### BRIEF DESCRIPTION OF THE DRAWINGS

FIG. 1 is a general network view of the start site in accordance with the present invention and how it, in accordance with a first embodiment, communicates with a mobile telephone over different networks,

FIG. 2 is similar to FIG. 1 and illustrates the case when the start site uses OTA configuration messages that are sent via Internet,

FIG. 3 is similar to FIG. 1 and illustrates the case when the start site is a WAP gate-way that uses SMS configuration messages that are sent via Internet

FIG. 4 is a perspective view showing a WAP enabled mobile telephone and a suite of WAP cards by which the start site of FIG. 3 interacts with the mobile telephone,

FIG. 5 is a flow diagram showing an exemplary configuration method used with the embodiment shown in FIG. 3

FIG. 6 is general network view of the start site in accordance with the present invention and how it, in accordance with a second embodiment, communicates with a mobile telephone over different networks,

FIG. 7 is general network view of the start site in accordance with the present invention and how it, in accordance with a third embodiment, communicates with a mobile telephone over different networks, and

FIG. 8 general network view of the start site in accordance with the present invention and how it, in accordance with a fourth embodiment, communicates with a mobile telephone over a public land mobile network.

### DETAILED DESCRIPTION OF PREFERRED EMBODIMENTS

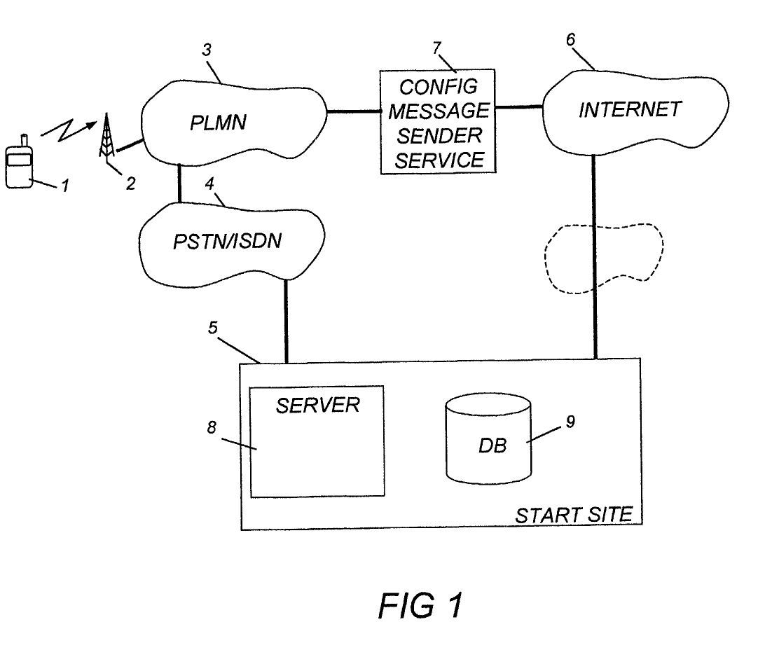

FIG. 1 shows a first general environment in which the invention is used. A mobile telephone 1 , below referred to as a mobile, shall be configured for digital services. It communicates with a base station 2 an a Public Land Mobile Network PLMN 3 which in turn is coupled to the Public Switched Telephone Network PSTN 4 or to an Integrated Service Digital Network ISDN. A start site 5 in accordance with the invention is connected to PSTN/ISDN and to Internet 6. A node referred to as configuration message sender service node 7 is connected to the Internet and to PLMN. The configuration message sender service node is a node that transmits configuration messages to mobile telephones in the PLMN. In PLMN such messages are sent over radio to the mobile telephones. The start site comprises a server 8 and a data base 9.

The invention starts from the fact that a user has bought a mobile which has been programmed by its manufacturer with a telephone number that leads to the start site.

The mobile has non-shown client software for exchange of information with the start site. The mobile telephone also has, in a manner known per se, a device that can receive and read configuration messages addressed to the mobile.

When the user bought the mobile he/she also bought a subscription on the service “mobile telephone” and on IP based data communication services.

Before the mobile can access the data communication services it needs to be configured. To configure it for the SMS service is a simple matter since the operator selected for the mobile services will usually provide the SIM card with the information which is necessary for activating the SMS service. If the operator hasn't done so, the customer configures the mobile for the SMS service in a conventional way. To configure the mobile for other data services is however difficult due to the above indicated reasons. So, in the embodiments of the invention to be described in connection with FIGS. 1-8 it is assumed the mobile can make phone calls and can receive SMS messages and SMS configuration messages. An SMS configuration message is an SMS message provided with a special marking that makes it to an SMS configuration message.

Configuration of the mobile for data services implies the setting of certain parameters in the program software of the mobile. Swift and simple configuration of the mobile is accomplished by way of interaction between the mobile and the start site in accordance with the present invention.

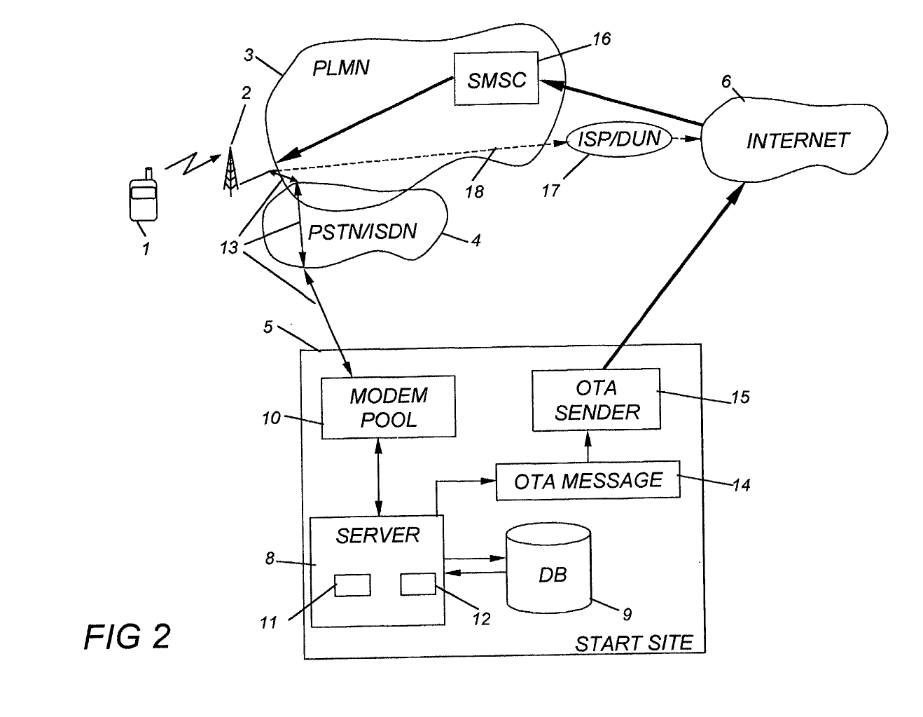

A first embodiment of the various steps configuration process will be described in connection with FIG. 2. In this embodiment the configuration message is an OTA configuration message. OTA is an acronym for Over The Air. An OTA message is a kind of a SMS message in which flag has been set. SMS is an acronym for short message service, a service that allows transmission of short text messages.

1. When the mobile is switched on for the first time the user makes a phone call to the pre programmed telephone number.

2. The call is terminated in a modem pool 10 connected to the server 8. The server has client software 11 that structures data that is exchanged between the server and the mobile. Said data is structured into a format that can be read by the mobile and by the server.

3. In response to the call an interactive exchange of information takes place between the start site and the user in a user-friendly, easy to understand language.

4. In the mobile's display the server presents, via the client software, fields into which the user is prompted to enter information. Typically the user is requested to enter his/her user name and password for each one of the communication services the user has subscribed to.

5. The server also interacts with the data base 9 under control from the control software 12. The data base contains data that is used configure the mobile for access to the data communication services. How data is entered into the data base is outlined below. The connection between the mobile and the start site over which this information is exchanged is illustrated by double headed arrows 13.

6. The server also requests the user to provide the name of the network operator at which the subscription was bought. In response to receipt of the selected network operator the web server fetches the latest information stored in the database concerning the selected network operator and the configuration information required by the mobile to access the communication services the user has subscribed to.

The server also request the user to provide the telephone number to the mobile. Some PLMN systems has a Calling Line Identification service that automatically provides the server with the mobile's mobile telephone number.

7. The configuration information thus received from the mobile and the configuration information read from the data base are stored by the server in an OTA configuration message 14.

8. If the data in the data base is incomplete the server asks the user to provide the missing information.

9. When the information gathering process is finished, the call is ended and the connection between the mobile and the start site is cleared.

10. The start site also comprises an OTA sender device 15 by which the OTA configuration message filled with the gathered configuration information is addressed to the mobile and is transferred to an SMS message sending service node 16 which further to administering SMS messages also administers OTA messages. Typically the SMS message sending service node is a SMS centre, SMSC, connected to PLMN and to the Internet. The destination address of the OTA configuration message is the telephone number to the mobile.

11. The OTA configuration message is transferred over PLMN to the base station and from there over radio to the mobile. The path the configuration message follows from the start site to the base station is indicated by single headed heavy arrows in FIG. 2. The mobile takes the incoming OTA configuration message and functionality resident in the mobile typically displays the following information to the user “Do you accept your telephone is configured by the information contained in this message? YES/NO?”. If the answers is “YES” software within the mobile will automatically configure the telephone with the information received in the OTA configuration message. This completes the configuration process.

12. Once the mobile is configured the user can start to use the data communication services or services that use data communication services he/she subscribes to. The manner in which these services are accessed will depend on the bearer service used by the mobile and on the browser used. Examples of bearer services for data communication services are the Short Message Service, SMS, the Circuit Switched Data Network, CSDN, the General Packet Radio System, GPRS, the Universal Mobile Telephony Standard, UMTS, the Enhanced Data Rates for GSM Evolution, EDGE and others.

Other examples of the client software for exchange of information are mobile telephone browsers that can read a Wireless Markup Language page (WML-page), a Hyper Text Markup Language page (HTML-page), an XML page, a wireless application protocol page (WAP page) or client software can read text that is structured in a predetermined manner which is known to the mobile and to the start site. A program that is stored in a memory module in the mobile embodies the browser.

If the mobile supports CSDN or GPRS and has a browser that can read HTML pages the access will take place in the manner just described.

When the user wants to access any one of the data services subscribed to he/she makes a circuit switched data call or initiates a packet switched data call on his/her configured mobile. The address of the call has been set by the configuration parameters.

When the user wants to access a digital communication service and makes a data call on the mobile, which has been configured in accordance with the invention, a data call is made on the mobile. The data call goes to an Internet Service Provider, ISP 17, that belongs to or is used by the network operator the user indicated for this service. This call, illustrated by the dashed arrow 18, is similar to a Dialled Up Connection, DUN, which is made from the modem of a Personal Computer, PC, to a modem pool at the ISP when Internet is to be accessed using the Microsoft browser Explorer. Once connected to the ISP, the mobile can browse home page of the service and use the service.

It should be noted that the start site must have knowledge of the mobiles it configures, in particular the bearer service the mobiles the mobiles use and the client software they have.

It should be noted that an OTA message comprising configuration information is sent from the start site to the mobile irrespective of the bearer services used. That is irrespective of the type of mobile used, be it a WAP enabled mobile, a GPRS enabled mobile, or a UMTS enabled mobile.

Examples of OTA-messages used with PLMN are the Short Message Service, SMS, and the Multi Media Message Service, MMS.

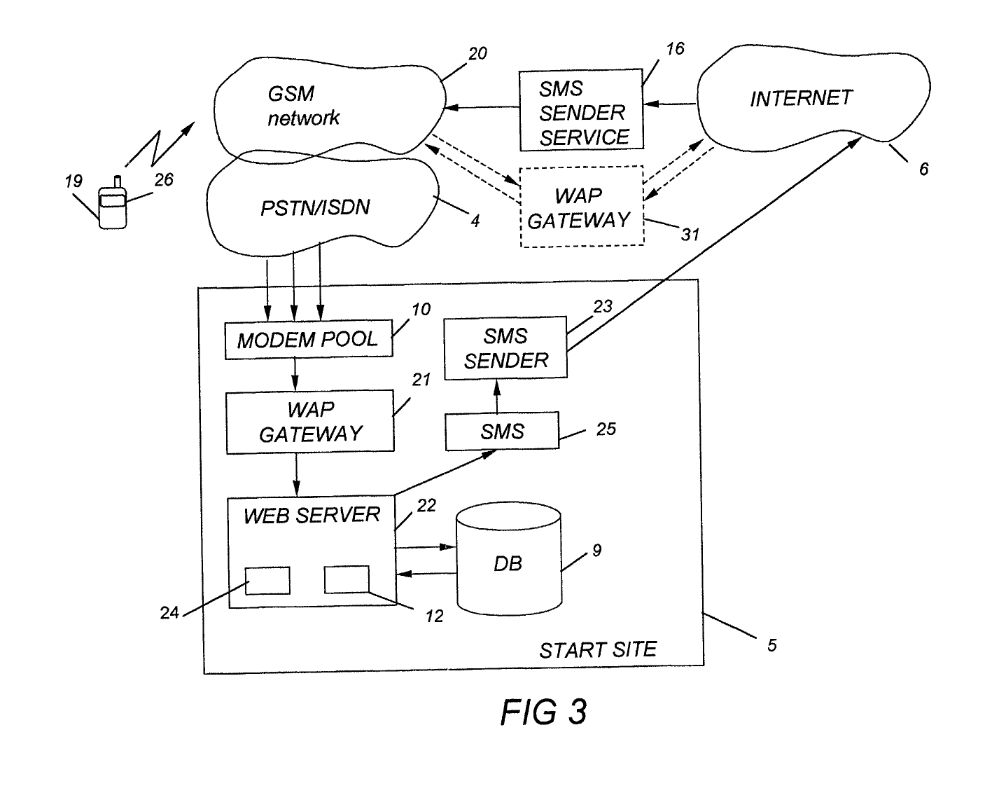

Turning now to FIG. 3 there is shown an embodiment of the invention wherein the mobile is a WAP enabled mobile and uses SMS as bearer service of the data communication service.

In FIG. 3 reference numeral 19 denotes a WAP enabled mobile. A WAP enabled telephone has a WAP browser that allows presentation of WML pages. The mobile has access to a GSM mobile telephone network 20 which is connected to the public telephone network 4. The mobile has a non shown SIM card with a GSM subscription that supports data communication services provided by a network operator. It is supposed the mobile is configured to receive SMS messages. Before the mobile can access the data communication services it needs to be configured, that is certain settings of the mobile must be made.

Swift and simple configuration of the mobile is accomplished by way of interaction between the mobile and start site 5 in accordance with the present invention. The start site comprises, further to the modem pool 10, a WAP gate way 21, a web server 22, the data base 9 and an SMS message sender 23. The web server comprises a WAP application 24. The control software 12 controls the interaction between the WAP gate way, the web server, the data base and the SMS sender. A configuration SMS message prepared by the control software is shown at 25. The mobile has a display 26. The WAP gate way has no access to Internet.

A main task of the WAP gate way is to reformat data of a web page from a web representation to a WAP representation and vice versa. Data in the WAP representation is more compressed than in the web representation so as to allow for efficient transmission over radio.

The web server is a standard web server that presents web pages. In this particular embodiment it is set to transmit WAP pages described below to the mobile.

The pre-programmed telephone number in the mobile is preferably an international free phone number. The configuration process is similar to the one described in connection with FIG. 2.

The WAP application is software that provides WAP cards used for interaction with the customer. These cards will be further described below. Expressed in a very general way the WAP application provides configuration pages that are displayed to the customer in the mobile's display and that are to be filled in by the customer during the call to the start site. The language used on the WAP cards is easy to understand for an inexperienced customer. It should be observed that although the user has not yet received his WAP settings—these are provided during the configuration of the mobile which takes place after reception of the configuration SMS message—the mobile is interacting with WAP pages during the call.

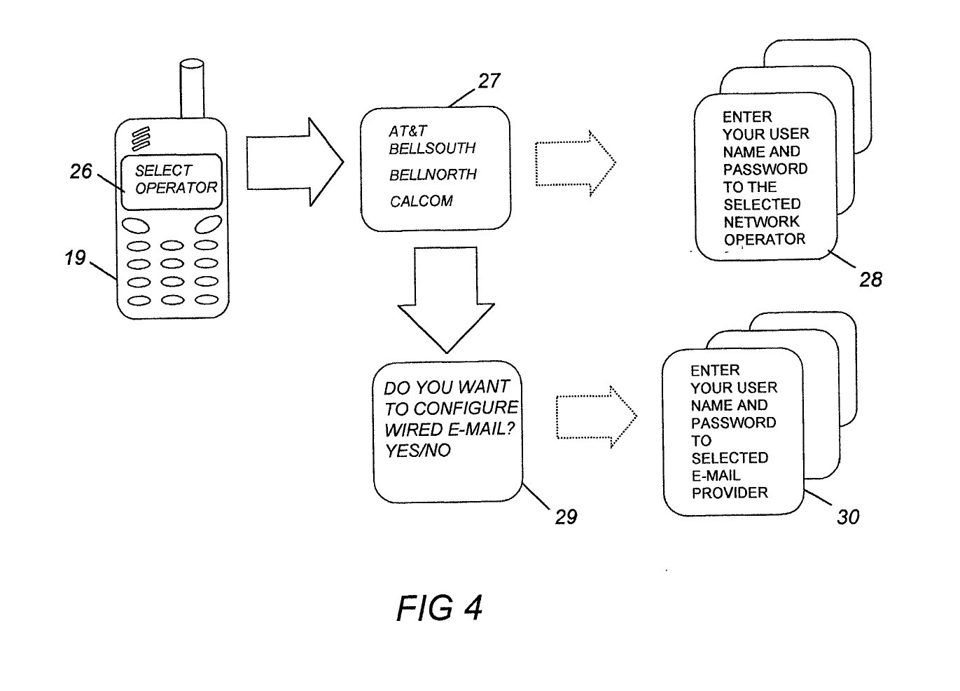

When the mobile makes a call to the pre-programmed telephone number, the call is terminated by the start site. The WAP gate-way will, in response to the call, download a WAP deck with WAP cards which are presented to the user in the display of the mobile. One of these cards, for example card 27 shown in FIG. 4, will ask the customer to select network operator, from the displayed list of operators. The customer selects network operator and the name of the selected network operator is transferred to the start site over the connection. In response to receipt of the selected network operator the web server fetches the latest information stored in the database concerning the selected network operator.

The data base comprises information relating to all WAP gate-ways within the region or country, their operators, their respective telephone numbers, and their properties. It further includes information on all of the most common e-mail service providers, their respective SMTP-servers and POP3-servers and details on these.

Next the start site identifies the calling customer using the CLI service. This will provide the start site with the mobile telephone number of the calling mobile. Since the mobile telephone number is associated with the customer's address it will also provide the start site with the name of the caller.

Next the control software checks the database for the latest individualised information relating to the identified telephone number, typically user name and password for access to each of the data communication services that the customer subscribes to.

The name of the customer will also be used in connection with configuration of the “wireless” e-mail service described below.

Depending on if the selected network operator has provided the start site with the calling customer's individual information or not two cases may occur. In the first case the network operator has had sufficient time to supply the calling customer's individual information to the start site. In the second case the operator has not yet supplied the individualised information to the start site.

In the first case the start site has all necessary individualised information in its database and the control software places said information in the configuration SMS message. The configuration SMS message is not yet sent to the mobile.

In the second case the customer is informed by a further WAP card 28 that he needs to enter his username and password to the selected network operator. The format of the username is typically a character string such as e.g. a010444010 and the password is typically also a character string such as e.g. 59r9Xa7G. This information typically appears from papers the customer receives from the network operator when he subscribes to mobile telephony services.

E-mail over “wireless Internet” is expected to become a major wireless Internet application. To help the customer to have this service available right at the start another WAP card 29 will ask the customer “Do you want to configure “wireless” E-mail? Yes/No?”. I the answer is “yes” two options arise, one being that the customer already has an e-mail account with an e-mail provider and the other being that he has not. In the first instance there are two options; either the selected e-mail provider has already provided the database with the calling customer's individualised, e-mail related information, or he has not. Is the individualised information already in the database said software will place it in the SMS message on hold. Next the customer is requested to press a SUMBIT button on the WAP card and the SMS configuration message on hold is sent by the SMS sender to the SMS sender service node 16 via Internet. The SMS sender service is connected to the GSM network. The above described, identified telephone number is used as address for the configuration SMS message. Next, the start site disconnects the call.

When the SMS configuration message is received by the mobile, control software existing therein will unpack the information contained in the SMS message and use it to configure the mobile. This completes the configuration process.

Once the mobile has been configured for the data communication services these are available to the customer on the mobile. These data services are provided by Internet via a conventional WAP gate way 31 which is shown by the dashed rectangle in FIG. 3.

In the case the customer's individualised e-mail related information is not already stored in the database the customer is requested, by another WAP card to select e-mail provider from a list of all major e-mail providers and to enter, on still another WAP card 30, his individualised e-mail related information, such as user name and password at the selected e-mail provider. The information is stored in the SMS message on hold and the customer is requested to press the SUBMIT button on the WAP card. The connection is disconnected and the SMS message on hold is sent.

If the customer has no existing e-mail account and he has indicated in WAP card that he wants “wireless” e-mail, the customer will be offered a “wireless” e-mail account. The web server will create customer specific configuration information (typically e-mail address, username and pass word) and will fetch e-mail related configuration information such as Domain Name Server (DNS), owner of the IP address, type of IP address (exclusive IP address for the calling customer or IP address shared among several customers) from the database and place it in the previously mentioned SMS message still on hold. This e-mail related configuration information will among other things specify an e-mail server that is operated by the owner of the start site.

The customer's name would typically already exist in the database and the web server would fetch it from there and add the start site owner's URL domain name to it. The address format is typically nameof.customer@startsiteownername.com. The address is transferred via a WAP card to the mobile's display so the customer can read it and make a note of it. It is also stored in the mobile.

The start site will thus allot the calling customer an e-mail address and will inform the e-mail server on the new e-mail account. All information of the e-mail servers, gate-ways, hosts etc. are known to the start site and this information is placed in the SMS message. Next the customer is requested to press the SUMBIT button. The SMS message on hold is sent in the manner described above, the call is disconnected, the SMS message is received by the mobile and the configuration process is completed as already described.

Calls made to the start site with the free phone number are paid by the owner of the start site. It is in the interest of the start site owner to keep the costs for free phone calls low and therefore the WAP gate-way has no connection to Internet.

Preferably the manufacturer of the mobile is the owner of the start site.

The start site may also include information on content providers an the Internet so that the selection of a particular network will also initiate a number of bookmarks and what start page the configured mobile should use.

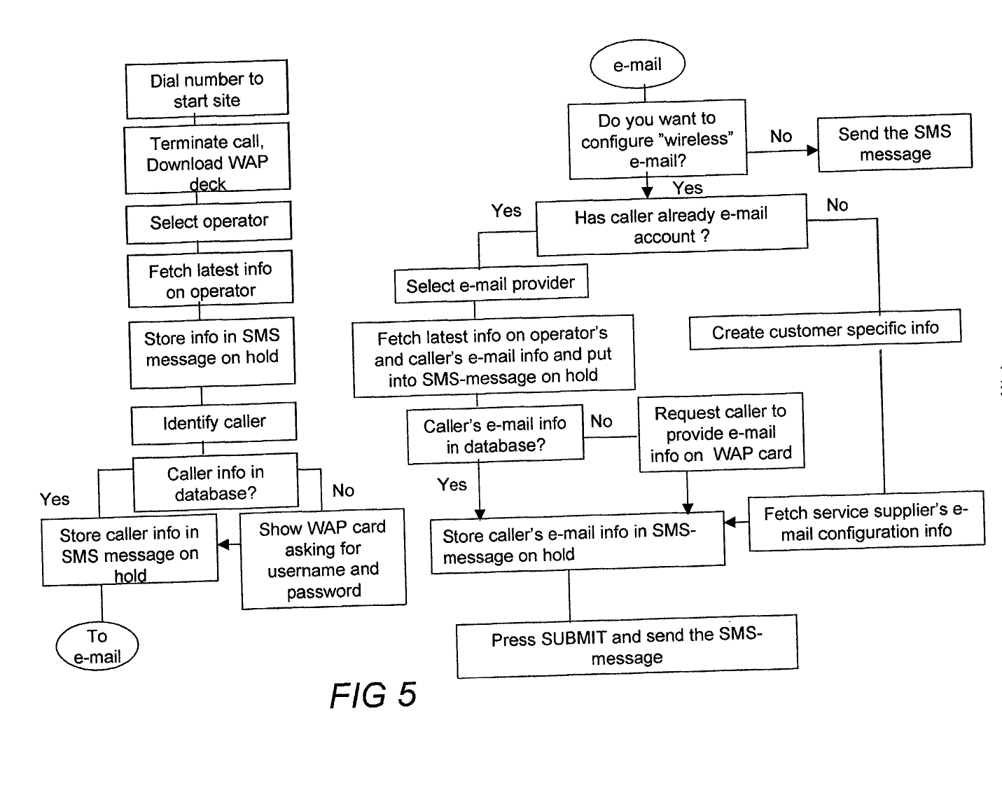

In FIG. 5 the various steps used for the configuration of the mobile in FIG. 4 are shown. They are self explanatory and need not be described once again.

Further Embodiments of the Invention

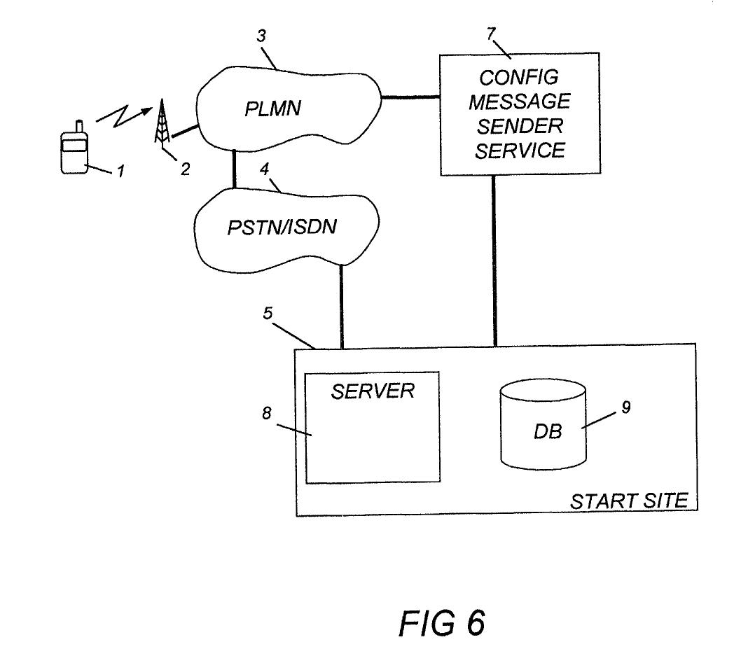

In the above embodiments the start site sends the configuration message via Internet and a configuration message sender service node connected to Internet. In a modification of the embodiment shown in FIG. 1 the configuration message can be sent to Internet via sub-nets, one such being shown at the dashed network in FIG. 1. In the embodiment shown in FIG. 6 the start site sends the configuration message directly to the configuration message sender service node, which in its turn sends it to the mobile over PLMN. In FIG. 6 The configuration steps are similar to those described in FIG. 1 and FIG. 2.

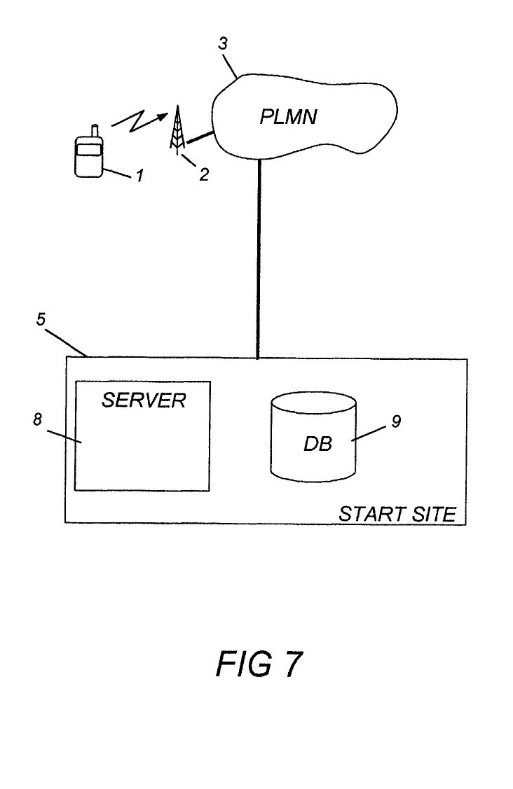

In FIG. 7 still another modification of the invention is shown. In this modification the configuration message is sent to the mobile directly, avoiding the use of a separate message sender service. As previously the start site interacts with the mobile's user and also with the data base 9 in order to compose a configuration message. Client software in the start site sends the configuration message to the mobile preferably on the same connection in PLMN as the one which is established when the mobile makes its first call to the start site. In the alternative is the latter connection disconnected and the start site makes a new call to the mobile and transmits the configuration message.

In the embodiment shown if FIG. 7 text or graphics exchanged between the start site and the mobile is structured in a predetermined manner which is known to the mobile and to the start site. The client software may in other word be of non-standard character. Further to this client software used for the configuration, the mobile may have a standard browser used for reading Internet web pages, for example WAP pages. The configuration steps are similar to those described in FIGS. 1-5.

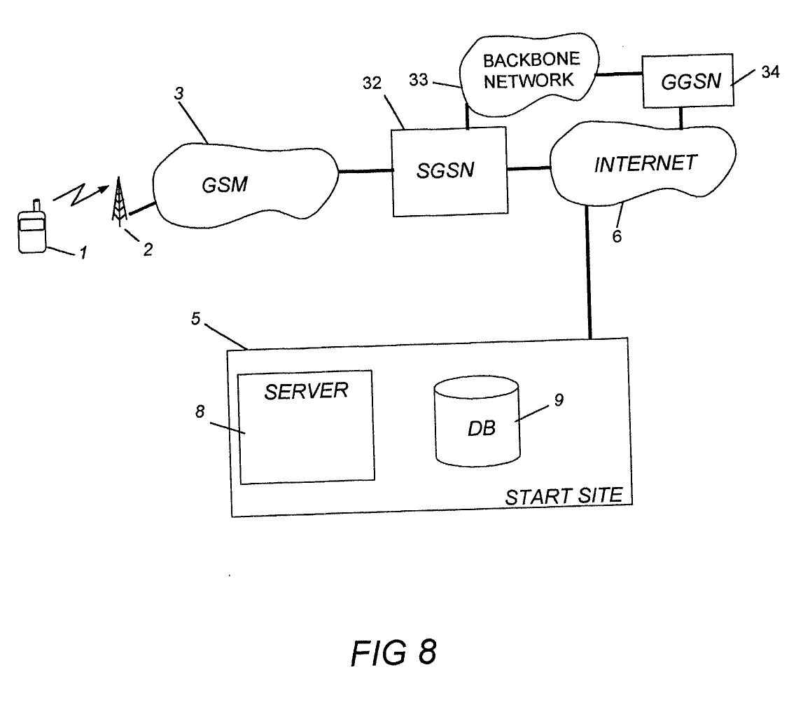

In the embodiment shown in FIG. 8 the mobile interacts with the start site over the PLMN network and Internet. A serving GPRS support node 32, SGSN, is connected to Internet and to a back bone network 33. The GPRS node inter-works with a gate-way GPRS support node 34, GGSN, to allot the mobile an IP address when the mobile connects to the SGSN node. In this manner the start site can communicate with the mobile using the mobile's IP address. In this embodiment the mobile is pre-programmed with a telephone number which leads to the SGSN node and with the IP address of the start site. When the mobile has been allotted an IP address the mobile requests a connection be set up to the start site using the pre-programmed IP address. The steps of the configuration process are similar to those described in connection with FIGS. 1-4.

In all of the embodiments described above it is assumed the configuration message is sent in just one SMS or OTA message. Due to the limited size these messages have, it may be required to send the configuration information in several SMS or OTA messages. These several messages can, in a manner known per se, be linked or concatinated.

The call to the star site need not be the first call which is made on the new mobile. This call can for example be made after the user has made some conventional telephone calls. It is also possible that the mobile itself initiates the call to the start site, either as the first call it makes, or is the call to the start site initiated after the user has made some conventional telephone calls.

The order in which the various method steps described above may vary as may also the various WAP cards which are presented to the customer. The WAP cards presented to the customer will depend on the implementation of the invention. Instead of using separate WAP cards for selection of network operator and e-mail provider one single list may be used for selection of network operator; and once a network operator has been selected the implementation is such that e-mail provider is thereby also selected.

Sometimes a postal or content service supplier will bar access to his digital services for mobiles whose telephony subscription belongs to another service supplier. A customer that selects a particular network operator may therefor be warned by the start site that he must be a subscriber to the telephony services of the selected digital service supplier. This information is stored in the database and the warning is presented to the customer on a separate WAP card.

Other identification mechanisms may be used by the start site if the CLI service is not available, such as the use of a WAP card which has a field that request the customer to enter his mobile's telephone number.

Instead of manually dialling the number to the start site, this number is automatically dialled by the mobile if the user tries to use the WAP browser before the hand held has been configured for the data communication services.

Additional WAP cards to those described above will be presented to a calling customer. Such additional pages may for example be required in the following cases: (1) the network operator or the e-mail provider have not provided the start site with general information on domain server, gate-way, proxy server, WAP gate-ways, SMTP-servers and POP servers, (2) the selected operator does not bar a customer which has another network operator, i.e. different operators are used for the digital services and the telephony services. In these cases the calling customer has to provide operator specific information as well as his own individualised information on one ore more WAP cards. For example a WAP card will ask the customer to enter his name. Additional WAP cards present questions specifying the information items which the customer shall fill in. In order to be able to fill in said information the customer needs to have ready in front of him the subscription papers and any further documents received from the network operator and e-mail provider.

Depending on system design said additional WAP cards may have many different styles and are therefore not illustrated. For example check box lists may be used for the various selections and answers a customer is requested to provide.

If the calling customer wants a “wireless” e-mail but has no e-mail account the customer would have to enter his name or a name he would like to use in his e-mail address.

In case the calling customer is unable to provide correct configuration information, operator specific as well as individualised, a WAP card will offer the customer a default WAP gate-way service supplied by the start site owner. This service is not free and is accessed via a telephone number associated with charging.

The telephone number to the start site which is pre-configured into the mobile by the manufacturer of the mobiles or by operators at sales points of the mobiles. Thus when the mobile is taken from the shelf, it will have the telephone number stored therein.

Instead of having a free phone number programmed into the mobile a conventional telephone number, that leads to the start site, may be programmed into the mobile. In this case the caller would pay for the call to the start site. The start site would then have a connection to Internet; the callers can “surf” the Internet via the WAP gate-way 21 and the callers pay the costs for the Internet connection.

The start site may be owned by another body than the manufacturer, for example an individual company.

What I claim:

1. A method of configuring a mobile telephone for Internet access to digital services over radio, wherein a configuration message for said configuration is sent to the mobile telephone over radio and the mobile telephone in response to reception of the configuration message automatically configures the telephone in accordance with the configuration data within the configuration message, said mobile telephone being provided with client software for exchange of information and a display, said method being characterised by the following steps:
providing the mobile telephone, before it is sold, with a telephone number that leads to a start site,
making a call on the mobile telephone using said telephone number,
the start site taking said call and over the connection for said call interacting with the user of the mobile telephone via said client software to obtain from the user configuration information that the start site needs to complete a configuration message,
the start site transmitting the completed configuration message to the mobile telephone, and
the mobile telephone upon reception of the configuration message performing the configuration.

2. A method of configuring a mobile telephone in accordance with claim 1, characterised in that the start site has a data base that comprises general information, which relates to Internet servers of major network operators, and individualised information which relates to a user of the mobile telephone, said method comprising the further steps of:
the start site requesting the user, via the client software, to select network operator for digital services from a list of major network operators,
the user selecting the network operator and transmitting the selection to the start site,
the start site in response to the selection retrieving from the data base said general information of the selected network operator and said individualised information pertaining to the user and putting it in the configuration message.

3. A method of configuring a mobile telephone in accordance with claim 2, said data base comprising general information relating to major e-mail providers and individualised information relating to the user's e-mail account, said method characterised by the further step of requesting the user, via the client software, to select e-mail provider for wireless e-mail service,
the start site in response to said request retrieving from the database general information of the selected e-mail provider and individualised information relating to the user's e-mail account, and putting it in the configuration message.

4. A method of configuring a mobile telephone in accordance with claim 3, characterised in that the configuration message is sent over the connection for the call.

5. A method of configuring a mobile telephone in accordance with claim 3 and the mobile telephone has been configured for reception of OTA or SMS messages, said method characterised by the further steps of
releasing the connection with the mobile telephone when the start site has obtained said information from the user and
the start site transmitting the completed configuration message in the form of an OTA or SMS configuration message to an OTA or SMS sender service which in turn transmits it to the mobile telephone.

6. A method of configuring a mobile telephone in accordance with claim 5, characterised in that the start site transmits the OTA or SMS message to the OTA or SMS sender service via Internet.

7. A method of configuring a WAP enabled mobile telephone for access to digital services, wherein a SMS message for configuration of the mobile telephone is sent to the mobile telephone and the mobile telephone in response to reception of the SMS message automatically configures the telephone in accordance with the transmitted configuration data, said method being characterised by the following steps:
storing in a database general information which relates to WAP servers of major network operators,
storing in said database individualised information which relates to an individual subscriber,
providing the mobile telephone with a telephone number to a start site that comprises a data base,
the subscriber making a call to the start site using said telephone number and said mobile telephone,
downloading to the mobile telephone, in response to said call, WAP-cards instructing the subscriber to select network operator for digital services
retrieving from the database said general information of the selected network operator and said individualised information, and
putting said retrieved information into said SMS message, and
transmitting from the start site, in a manner known per se, said SMS message to the individual telephone.

8. The method in accordance with claim 7, characterised by
temporarily delaying said SMS message after the step of putting said retrieved information into the SMS message,
downloading of a further WAP-card instructing the subscriber to select e-mail provider for wireless e-mail service,
retrieving from the database said general information of the selected e-mail provider and individualised information relating to the individual subscriber, and
putting said retrieved general as well as individualised information relating to e-mail into said temporarily delayed SMS message, and performing said transmission step.

9. The method in accordance with claim 7, characterised in that said general information related to network operator relates to a WAP gate-way of the selected operator, the telephone number to said WAP gate-way and the properties of said WAP gate-way.

10. The method in accordance with claims 7 or 8, characterised in that said individualised information related to network operator relates to the subscriber's user name and password at said selected network operator for access to said digital services.

11. The method in accordance with claim 10, characterised in that the individualised information related to said network operator is provided to the start site's database by the selected network operator.

12. The method in accordance with claim 11, characterised in that the individualised information related to said network operator is provided to the start site's database by the subscriber at a request which is displayed to the subscriber on a further WAP card that the start site downloads to the mobile telephone.

13. The method in accordance with claim 12, wherein the individual subscriber of the mobile telephone already has an existing e-mail account characterised in that said general information related to the selected e-mail provider relates to SMTP server, POP3 server and telephone number to the selected e-mail provider.

14. The method in accordance with claim 13, characterised in that that the individualised information related to said e-mail service is provided to the start site's database by the selected e-mail provider.

15. The method in accordance with claim 13, characterised in that the individualised information related to said e-mail service is provided to the start site's database by the subscriber at a request which is displayed to the subscriber on a further WAP card that the start site downloads to the mobile telephone.

16. The method in accordance with claim 13, characterised in that the individualised information related to said e-mail service comprises the subscriber's user name and password.

17. The method in accordance with claim 13, characterised in that the start site identifies the individual subscriber.

18. The method in accordance with claim 7, wherein the individual user does not have an existing e-mail account characterised in that the individual user is offered an e-mail account for wireless e-mail service at the owner of the start site.

19. The method in accordance with claim 18, characterised in that the start sit allots the subscriber an e-mail address which it displays to the customer on a further WAP card.

20. The method in accordance with claim 7 characterised in that the telephone number to the start site is pre-configured into the mobile telephone by the manufacturer of the mobile telephones or by operators at sales points of the mobile telephones.

21. The method in accordance with claim 20 characterised in that the telephone number to the start site is a free-phone number.

22. A start site for configuring a mobile telephone for access to digital services over a WAP connection, characterised by a modem pool connected to the public telephone network, a WAP gate-way connected to the modem pool and to a web server, and a data base connected to the web server, said WAP gate-way provided with
means for downloading a WAP deck to a mobile telephone,
said WAP deck comprising a WAP card requesting an individual subscriber that makes a call to the start site to select a network operator,
software means for retrieving from the database general information relating to the digital services of the selected network operator as well as to individual information relating to an individual subscriber and for putting said information into a configuration SMS message,
means (9) for sending a configuration SMS to the mobile telephone.

23. A start site in accordance with claim 22, characterised by said software means being arranged to temporarily delaying said SMS message and to retrieve from the data base general information of the selected e-mail provider as well as to individualised information relating to the individual subscriber's e-mail account and for putting said retrieved information into the temporarily delayed SMS message.

24. A start site in accordance with claim 22, characterised in that said WAP gate-way (6) is barring access to the Internet for incoming calls that use a predefined telephone number.

25. A start site in accordance with claim 22, characterised in that the data base comprises information relating to major WAP gate-ways within the region or country, their respective telephone numbers, and their properties.

26. A mobile telephone enabled for exchange of information with Internet, the mobile telephone having a display and client software allowing presentation of configuration information characterised in that on delivery from the shelf the mobile telephone is pre-configured with a telephone number that goes to a start site for composing and transmission of a configuration message to the mobile telephone, said configuration message configuring the mobile telephone for digital communication services provided by Internet.

27. A mobile telephone in accordance with claim 26, characterised in that it is pre-programmed with an IP address of the start site.

28. A mobile telephone in accordance with claim 26 or 27, characterised in that the client software is a standard mobile telephone browser.

29. A mobile telephone in accordance with claim 26 or 27, characterised in that the client software is a non-standard mobile telephone browser known to the start site and the mobile telephone.

30. A mobile telephone in accordance with claim 28 or 29, characterised in that the mobile telephone further to the client software, with which the mobile communicates with the start site, has a standard mobile telephone browser by which the mobile telephone, after configuration by means of the configuration message, communicates with Internet sites.
